(19) United States
(12) Patent Application Publication
(10) Pub. No.: US 2025/0179258 A1
(43) Pub. Date: Jun. 5, 2025

(54) METHOD FOR CURING VINYL ESTER RESIN

(71) Applicant: NATIONAL CHUNG SHAN INSTITUTE OF SCIENCE AND TECHNOLOGY, Taoyuan City (TW)

(72) Inventors: YI-KANG LAN, Taoyuan City (TW); KAN-RU LIN, Taoyuan City (TW)

(21) Appl. No.: 18/527,399

(22) Filed: Dec. 4, 2023

(51) Int. Cl. C08J 3/28

(52) U.S. Cl. CPC C08J 3/28; C08J 2367/06

(57) ABSTRACT

The present disclosure provides a method for curing vinyl ester resin, which comprises: (a) providing a first composition comprising a vinyl ester monomer; (b) adding a photosensitizer and a peroxide as a co-initiator to the first composition to form a second composition; and (c) irradiating the second composition with an actinic ray to cure the second composition.

### BACKGROUND OF THE INVENTION

### 1. Field of the Invention

The present disclosure relates to a method for curing vinyl ester resin, and in particular to a method for curing vinyl ester resin using a photosensitizer and a peroxide as a co-initiator.

### 2. Description of the Related Art

Vinyl ester resin is produced by the esterification reaction of epoxy resin and methacrylic acid. Both ends of vinyl ester resin have a long-chain molecule with an unsaturated vinyl group. At normal temperature, vinyl ester resin is used with styrene solvent to form liquid glue.

The characteristics of vinyl ester resin lie in that it has superior glass fiber impregnation amount, high mechanical strength, high elongation at break and high thermal denaturation temperature, and has better weather resistance and corrosion resistance, so it can pass the ship class certification and is suitable for marine environment. Currently, for example, offshore fan blades, fairings and nose cones, yacht/ship hulls, upper masts of ships, and underwater sonar covers all use vinyl ester resin in large quantities. For example, the vinyl ester resin of model 901-V produced by Swancor Corp. has a heat deflection temperature (HDT) of about 110° C. This vinyl ester resin can be used with glass fibers to produce large hull/marine composite materials through vacuum infusion, i.e., vacuum assisted resin transfer molding (VaRTM), and the time when curing begins to occur can be controlled by adding curing agents, initiators and retarders.

The curing of vinyl ester resin utilizes free radical reaction to open double bonds of monomers for crosslinking. The reaction needs to be triggered through the attack to double bonds by the initiator (cobalt salts) and the curing agent (peroxides, such as MEKPO). Compared with ordinary resins, the free radical curing reaction of vinyl ester resin cannot occur on its own at room temperature and requires the cooperation with the initiator and the curing agent. When the room temperature is lower than 15° C., the free radical reaction will quench and fail.

Once the free radical reaction starts, the reaction speed is fast and accompanied by the release of a large amount of reaction heat. When the thermal conductivity of the workpiece is poor (such as being too thick or having a core material layer), a large amount of the released reaction heat will accumulate, causing the temperature to rise. Although this high temperature condition can promote the curing reaction, when the temperature changes too rapidly, it will cause uneven curing of various parts of the workpiece, causing peeling and gaps at the resin-glass fiber interface, resulting in a decrease in interface strength. When the temperature is higher than the thermal deformation temperature of vinyl ester resin (˜110° C.) for a long time, it will cause internal softening and deformation of the product, resulting in uneven shrinkage rate, which leads to interface defects and locally concentrated stress. Severe heat release causes the resin to heat up too quickly, which will produce many defects and bubbles, further affecting the mechanical properties and limiting the applicability of vinyl ester resin products.

### BRIEF SUMMARY OF THE INVENTION

Photopolymerization uses photoinitiators to initiate the formation of free radicals during the polymerization process. Among them, photoinitiators can be divided into two categories. Type I photoinitiators decompose into free radical molecules after being excited by photons, require the use of strong energy ultraviolet light as the light source (UV curing), and have been industrially used in the fields of UV ink, UV printing, UV adhesives, etc. However, UV light sources have problems such as being expensive, not durable due to heat dissipation requirements and harmful to personnel when exposed, additional addition of UV absorbers to prevent deterioration, etc. Type II photoinitiators are visible light initiating systems, mainly organic dye photosensitizers (for example, rose of bengal, especially eosin Y), which can generate activated substances under visible light irradiation and then initiate the polymerization or cross-linking reaction of monomers or oligomers and have been widely and successfully used in visible light organic synthesis. Both types of photoinitiators also have the problem of difficulty in penetrating deep into the workpiece (generally they can only penetrate 0.5 cm).

The current vinyl ester resin composite material manufacturing technology is to coat fiber reinforced materials with vinyl ester resin, and then complete the preparation of the composite material through curing of the resin. This technology cures vinyl ester resin by adding curing agents, initiators and retarders to control the time when curing begins and the speed of the reaction.

However, the current technology will encounter two problems. First, the free radical curing reaction of vinyl ester resin cannot occur by itself below room temperature (25° C.) and needs to be triggered by an initiator. When the room temperature is lower than 15° C. in winter, the free radical reaction will quench, causing the initiator to become ineffective and unable to cure; and in summer, if the room temperature is too high, the reaction will be too fast, and a retarder will need to be used to slow down the reaction time to facilitate the infusion of large workpieces. Secondly, the curing of vinyl ester resin uses free radical reaction to cross-link. Once the reaction starts, the reaction speed is fast and accompanied by the release of a large amount of reaction heat, leading to sharp rise of the internal temperature. The measurement results show that the center temperature can reach 180-220° C. If the heat dissipation of the workpiece is poor, the high temperature will cause defects or even deformation of the finished product. The temperature change rate of a rapid reaction will deviate from the original control range of the retardant or curing agent ratio. Therefore, current technology cannot overcome the problem of too rapid temperature increase and high temperature. When it comes to workpieces that are difficult to dissipate heat, the current method adopts layered and divided perfusion, but the overall strength will be sacrificed.

In order to improve the limitations of such initiators and curing agents, vinyl ester resins or systems with acrylic functional groups can start free radical reactions by directly breaking bonds with ultraviolet light, or use photosensitizers to generate free radicals for initiating the reaction. However, ultraviolet light is difficult to penetrate the processed workpiece (generally speaking, the penetration capability is less than 0.5 cm), and the ultraviolet light source is relatively expensive and not durable (heat dissipation problem). It can cause personal injury when exposed, and additional ultraviolet light absorbers must be added to the resin to prevent the resin from deteriorating. Compared with ultraviolet light sources, LED visible light sources are relatively environmentally friendly, low-cost, and safer to use than ultraviolet light sources. However, the energy and penetrating power of LED visible light sources are weaker than those of ultraviolet light sources, and cannot directly open bonds to generate free radicals without the addition of photosensitizers. Further, insufficient penetrating power will lead to incomplete polymerization in deep, which limits its disclosure.

The present disclosure proposes to combine a visible light photosensitizer with a free radical catalytic system and apply it to the overall polymerization reaction of vinyl ester resin. When the photosensitizer and peroxide are used as co-initiators, such dual/multiple catalytic system can replace the traditional cobalt salt initiator to initiate free radical reactions, and polymerization can be completed even at opaque sites deep in the workpiece. This technology can be applied to the vacuum infusion process of vinyl ester resin composite materials and, as compared with the existing technology, has the advantages that the curing temperature and time can be controlled to reduce defects, high-precision molding capabilities can be achieved, super-large parts can be infused at one time without the need for multiple infusions, and curing can be performed in low temperature environment, etc.

In general photopolymerization reactions, photosensitizers, such as Eosin Y, will serve as a direct provider of free radicals and play the role of an initiator. However, in actual conditions of the workpiece with thickness, the penetration of light is insufficient to stimulate the photosensitizer located deep in the workpiece to react, resulting in incomplete polymerization. As shown in FIG. 1, in order to improve this limitation, we design to add peroxide as the second-stage free radical initiator in the light reaction, so that the free radicals generated by the photosensitizer can trigger the peroxide to start a chain reaction and continue the generation of free radicals, which allows polymerization to proceed using the free radicals generated by peroxide in dark places (i.e., deep within the workpiece where light sources cannot reach) to achieve a complete reaction.

The present disclosure provides a method for curing vinyl ester resin, which comprises:
(a) providing a first composition comprising a vinyl ester monomer;
(b) adding a photosensitizer and a peroxide as a co-initiator to the first composition to form a second composition; and
(c) irradiating the second composition with an actinic ray to cure the second composition.

In the curing method described above, the vinyl ester monomer may be produced by an esterification reaction of an epoxy resin and methacrylic acid.

In the curing method described above, the first composition may further include a solvent.

In the curing method described above, the solvent may be styrene.

In the curing method described above, the photosensitizer may be Eosin Y.

In the curing method described above, the peroxide may be an organic peroxide.

In the curing method described above, the organic peroxide may be selected from the group consisting of benzoyl peroxide (BPO) and dilauroyl peroxide (DAPO).

In the curing method described above, the actinic ray may be visible light.

In the curing method described above, the actinic ray may have an intensity between 10W and 40W.

In the curing method described above, a content of the photosensitizer in the second composition may be between 0.1 wt % and 0.3 wt %.

In the curing method described above, the content of the photosensitizer in the second composition may be between 0.13 wt % and 0.2 wt %.

In the curing method described above, a content of the peroxide in the second composition may be between 0.5 wt % and 2.0 wt %.

In the curing method described above, the content of the peroxide in the second composition may be between 1.0 wt % and 2.0 wt %.

In the curing method described above, step (c) may be carried out under a condition of ambient temperature lower than 25° C.

In the curing method described above, step (b) may further comprise mixing the second composition with a fiber.

In the curing method described above, the fiber may be glass fiber.

### BRIEF DESCRIPTION OF THE DRAWINGS

FIG. 1 shows the curing principle of the method for curing vinyl ester resin of the present disclosure.

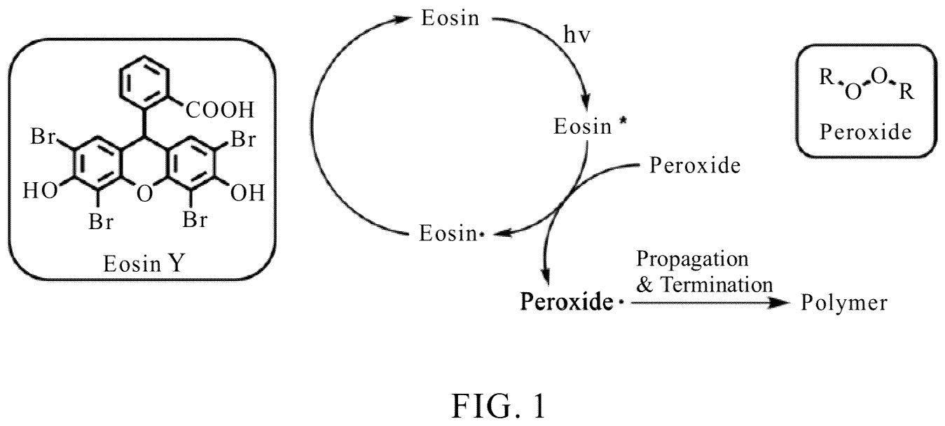

FIG. 2 is a flow chart of the method for curing vinyl ester resin of the present disclosure.

FIG. 3 shows the experimental results of Example 3.

FIG. 4 shows the experimental results directed to the photosensitizer content of Example 4.

FIG. 5 shows the experimental results directed to the peroxide content of Example 4.

FIG. 6 shows the experimental results of Example 5.

FIG. 7 shows the experimental results of Example 6.

FIG. 8 shows the experimental results of Example 7.

FIG. 9 shows the experimental results of Example 7.

FIG. 10 shows the experimental results of Example 8.

### DETAILED DESCRIPTION OF THE INVENTION

To facilitate understanding of the object, characteristics and effects of this present disclosure, embodiments together with the attached drawings for the detailed description of the present disclosure are provided.

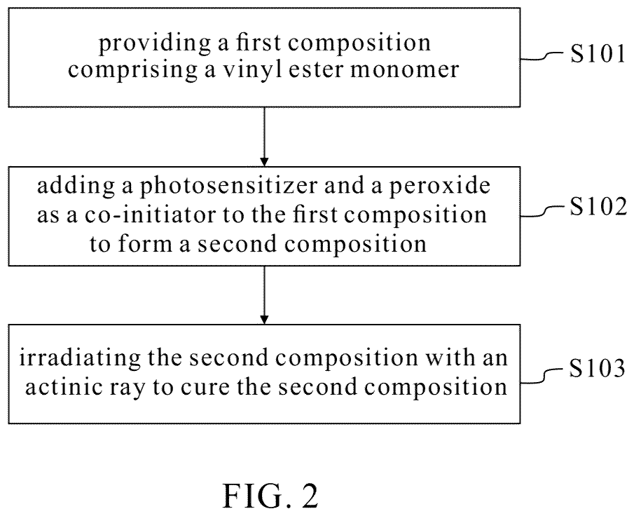

As shown in FIG. 2, the method for curing vinyl ester resin of the present disclosure comprises: (a) providing a first composition comprising a vinyl ester monomer (S101); (b) adding a photosensitizer and a peroxide as a co-initiator to the first composition to form a second composition (S102); and (c) irradiating the second composition with an actinic ray to cure the second composition (S103).

### Example 1: Standard Procedure for Polymerization Using Kessil LED Lamp as Light Source

Vinyl ester monomer (10-200 g), peroxide (0.5-2.0 wt %) and the photosensitizer (0.1-0.3 wt %) were added into a paper cup at one time and then stirred evenly. The probe of the thermometer was coated with some grease and wrapped with PE plastic wrap to prevent the probe from being unable to be taken out smoothly after the polymerization was completed. Afterwards, the probe was put into the paper cup, and the reactions were carried out using the light intensity of 10 W-40 W respectively after the light color corresponding to the absorption wavelength of the photosensitizer was selected (with a light source height of 10 cm). After the polymerization was completed, the probe was taken out and the recorded temperature was collected using the corresponding computer software. Finally, the paper cup outside the polymer was removed, and the periphery of the polymer was pressed with a scraper to confirm whether it was completely polymerized.

### Example 2: Standard Procedure for Polymerization Using 5050 LED Strip as Light Source

Vinyl ester monomer (10-200 g), peroxide (0.5-2.0 wt %) and the photosensitizer (0.1-0.3 wt %) were added into a rectangular paper box (with an illumination area of 104.5 cm²) at one time and then stirred evenly. The probe of the thermometer was coated with some grease and wrapped with PE plastic wrap to prevent the probe from being unable to be taken out smoothly after the polymerization was completed. Afterwards, the probe was put into the paper box, and the light source was turned on for reaction (0.11 W/cm²). After the polymerization was completed, the probe was taken out and the recorded temperature was collected using the corresponding computer software. Finally, the paper box outside the polymer was removed, and the periphery of the polymer was pressed with a scraper to confirm whether it was completely polymerized.

### Example 3: Polymerization Effects of Different Peroxides and Eosin Y in Visible Light (30 g Vinyl Ester Monomer, 0.6 g BPO/0.6 g DAPO, 75 mg Eosin Y, 2.5 cm Thickness)

A first composition comprising 30 g of vinyl ester monomer was provided, and 75 mg of the photosensitizer Eosin Y and 0.6 g of the organic peroxide, i.e. benzoyl peroxide (BPO) or dilauroyl peroxide (DAPO), were used as the co-initiator and added into the first composition to form a second composition, which was irradiated with an actinic ray, thereby curing the second composition.

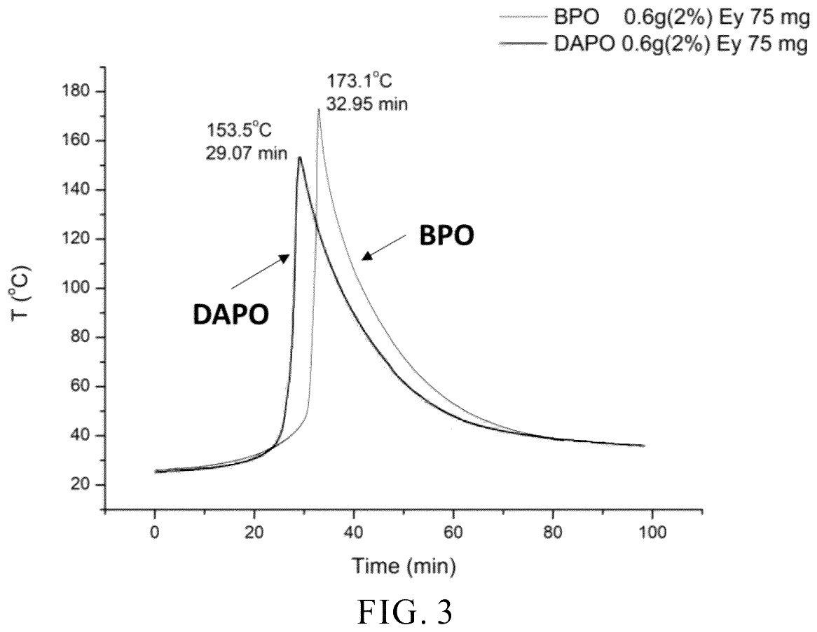

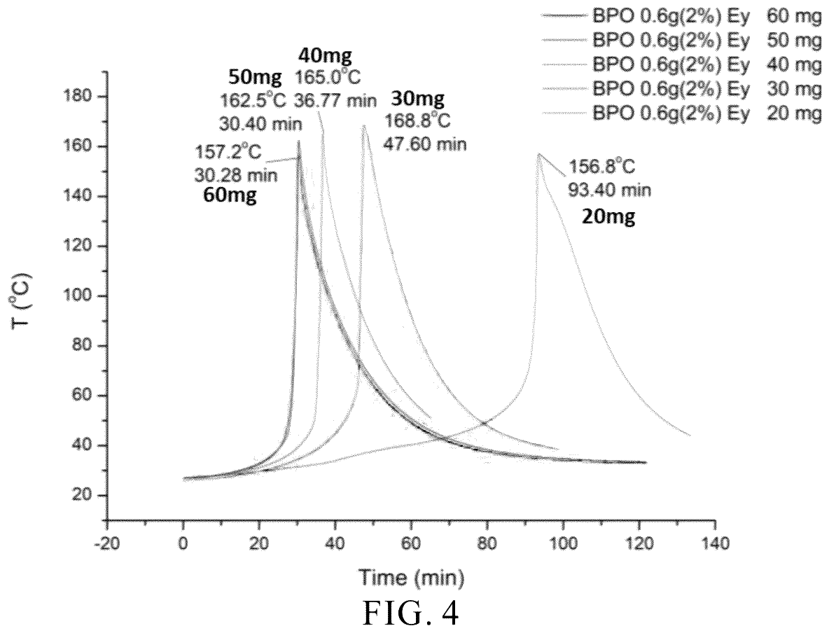

This example used different types of organic peroxides, such as commercially available benzoyl peroxide (BPO) and dilauroyl peroxide (DAPO), to study the impact on the polymerization reaction of the photosensitizer Eosin Y. As shown in FIG. 3 (Ey in FIG. 3 represents Eosin Y, the same applies to FIGS. 4-7 and 9-10 below), both BPO and DAPO can complete the polymerization reaction in the presence of Eosin Y photosensitizer, and the polymerization temperature of DAPO is 20° C. lower than that of BPO (153° C. vs. 173° C.).

However, after polymerization, DAPO will form a waxy white film on the surface due to its long carbon chain structure that needs to be removed. BPO did not have this problem. The results show that DAPO is a better peroxide choice than BPO when the system temperature needs to be suppressed, but the wax on the surface of the finished product needs to be removed by cleaning; and when using BPO, the dosage must be further adjusted to suppress the heat release.

### Example 4: Control of Eosin Y/BPO Polymerization Time and Exothermic Degree (30 g Vinyl Ester Monomer, 0.15 g, 0.3 g or 0.6 g BPO, 30 mg Eosin Y, 2.5 cm Thickness)

A first composition comprising 30 g of vinyl ester monomer was provided, and 30 mg of the photosensitizer Eosin Y and 0.15 g, 0.3 g or 0.6 g of the organic peroxide benzoyl peroxide (BPO) were used as the co-initiator and added into the first composition to form a second composition, which was irradiated with an actinic ray, thereby curing the second composition.

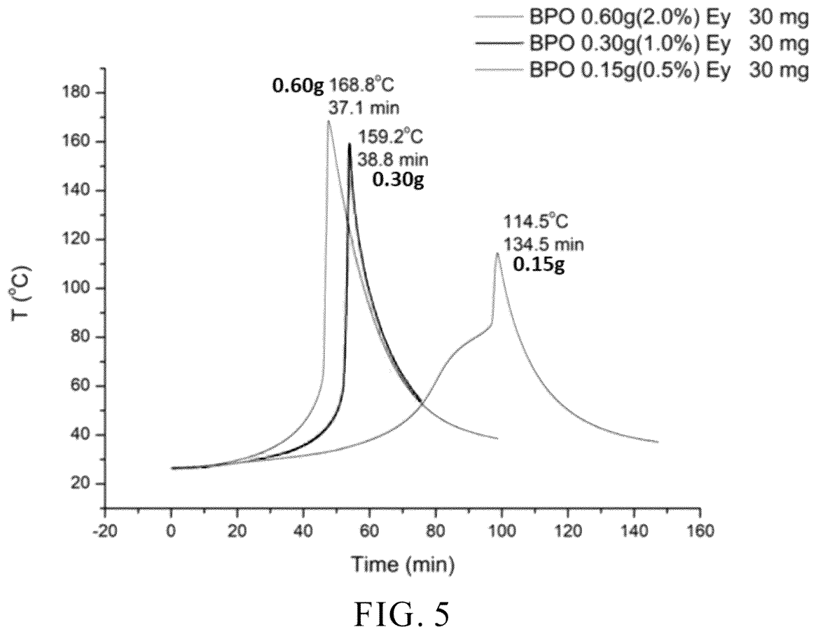

In this example, the degree of heat release during the curing process and the curing time are adjusted by changing the concentration of the initiator and the proportion of the photosensitizer, so that the disclosure end can select appropriate conditions according to different disclosure requirements. As shown in FIG. 4, the experimental results show that the photosensitizer proportion less than 0.13 wt % (40 mg/30 g) will affect the reaction speed; and as shown in FIG. 5, the peroxide concentration below 1% cannot maintain a good polymerization reaction.

Experimental results show that the polymerization temperature can be controlled by adjusting the ratio and concentration of the photosensitizer and peroxide. For example, if it needs to be controlled at 160° C., the optimal curing ratio is 0.13-0.2 wt % photosensitizer and 1.0-2.0 wt % peroxide.

### Example 5: Eosin Y/BPO/Resin Premix Stability Test (30 g Vinyl Ester Monomer, 0.6 g BPO, 30 mg Eosin Y, 2.5 cm Thickness)

A first composition comprising 30 g of vinyl ester monomer was provided, and 30 mg of the photosensitizer Eosin Y and 0.6 g of the organic peroxide benzoyl peroxide (BPO) were used as the co-initiator and added into the first composition to form a second composition, which was irradiated with an actinic ray, thereby curing the second composition to form cured vinyl ester resin with up to 2.5 cm thickness.

Traditionally, the resin, accelerator and curing agent must be stored separately before vacuum infusion of vinyl ester resin, and evenly mixed in proportion and then infused within the time limit during disclosure. However, this method is not only prone to uneven mixing, thereby leading to product deterioration, and curing will begin about 20-120 minutes after mixing (can be adjusted by the retarder). Super-large workpieces with an infusion time longer than this range need plural infusions in different heights/layers and cannot be formed at one time.

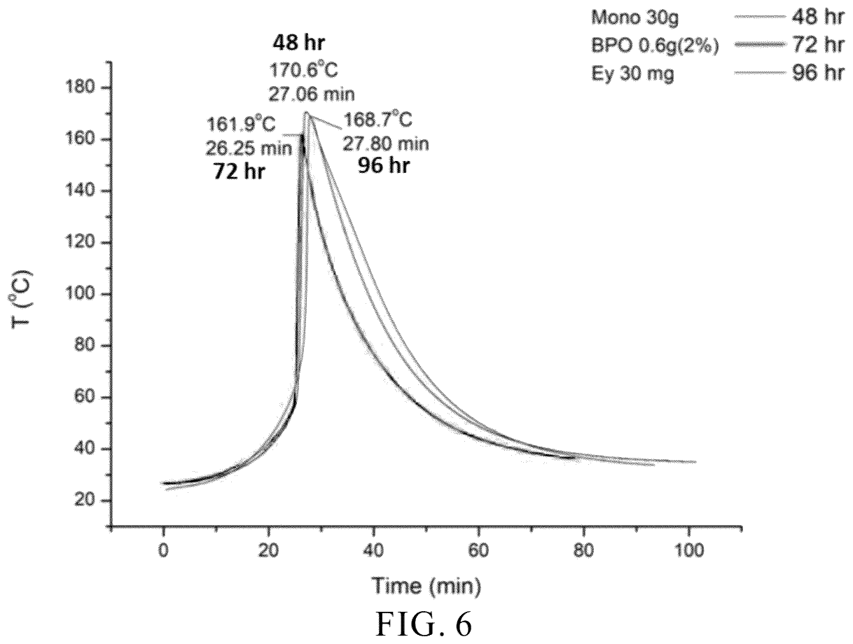

However, it can be seen from this example that the system of the present disclosure can overcome this limitation and possesses pre-mixability. Since a light source is required to initiate the reaction, the system of the present disclosure can be pre-mixed and stored in advance, and can be infused after all the dosage is prepared. Further, curing can be started after the infusion is completed and adjustments are confirmed, ensuring that the infusion is completed and fine portions can be micro-adjusted to meet high-precision thickness/detail requirements. The experimental results show that within 24 hours after premixing, the error in the curing time after starting the reaction with light is less than 10 minutes, and the reaction temperature can also be controlled within 160+10° C., showing that this formulation can enable the vinyl ester resin system to withstand long-term transportation or super-large workpiece infusion operation time. As shown in FIG. 6, even if the premixing exceeds 24 hours and then light is used to trigger the reaction, the results are stable.

### Example 6: Eosin Y-BPO System Scale-Up Test (200 g Vinyl Ester Monomer, 2 g BPO, 330 mg Eosin Y, 4 cm Thickness)

A first composition comprising 200 g of vinyl ester monomer was provided, and 330 mg of the photosensitizer Eosin Y and 2 g of the organic peroxide benzoyl peroxide (BPO) were used as the co-initiator and added into the first composition to form a second composition, which was irradiated with an actinic ray, thereby curing the second composition to form cured vinyl ester resin with up to 4 cm thickness.

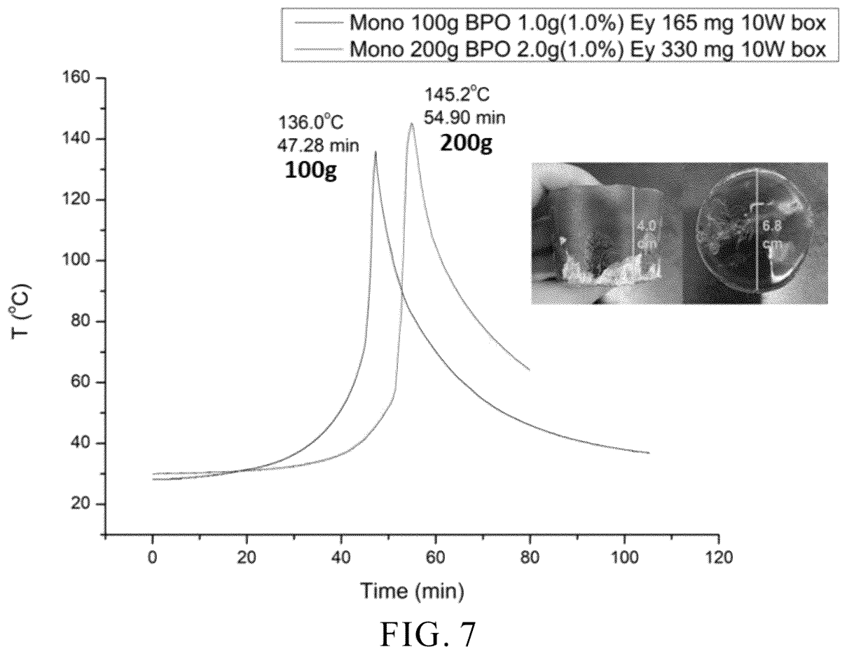

This example uses a small block polymerization experiment to evaluate the curing characteristics of large workpieces. As shown in FIG. 7, when the reaction scale is increased to 200 g of monomer, complete polymerization can also be carried out under similar reaction conditions, and the results are in line with the requirement that the reaction temperature be lower than 160° C. The photos in

FIG. 7 are side views and top views of cup-shaped block-shaped polymer products. It can be seen that according to this example, polymers with a thickness of 4 to 7 centimeters can be completed without defects, which is enough to complete large-scale workpiece requirements.

### Example 7: Test of the Influence of Light Intensity/Light Source Distance on Polymerization Reaction (100 g Vinyl Ester Monomer, 1 g BPO, 165 mg Eosin Y, 4 Cm Thickness)

A first composition comprising 100 g of vinyl ester monomer was provided, and 165 mg of the photosensitizer Eosin Y and 1 g of the organic peroxide benzoyl peroxide (BPO) were used as the co-initiator and added into the first composition to form a second composition, which was irradiated with an actinic ray, thereby curing the second composition to form cured vinyl ester resin with up to 4 cm thickness.

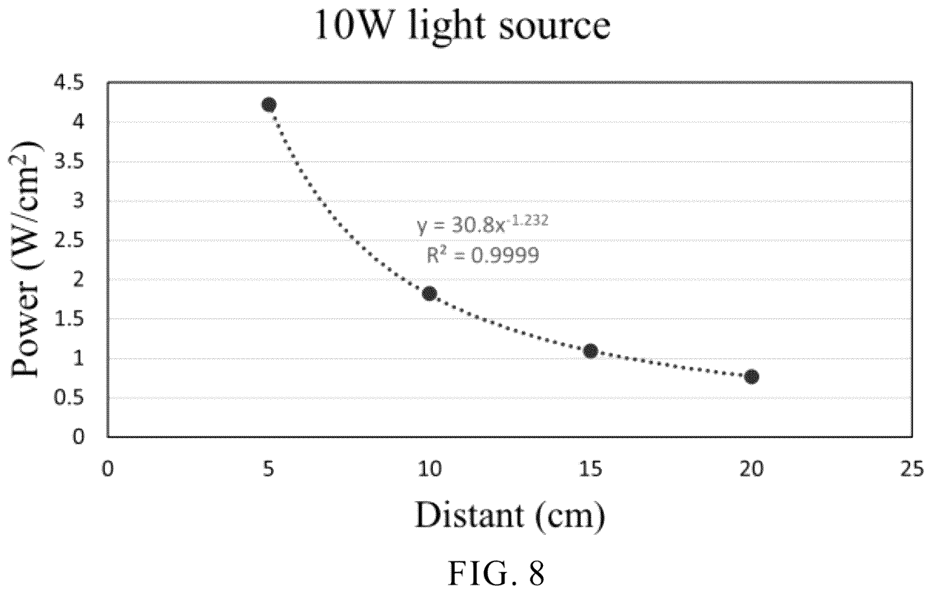

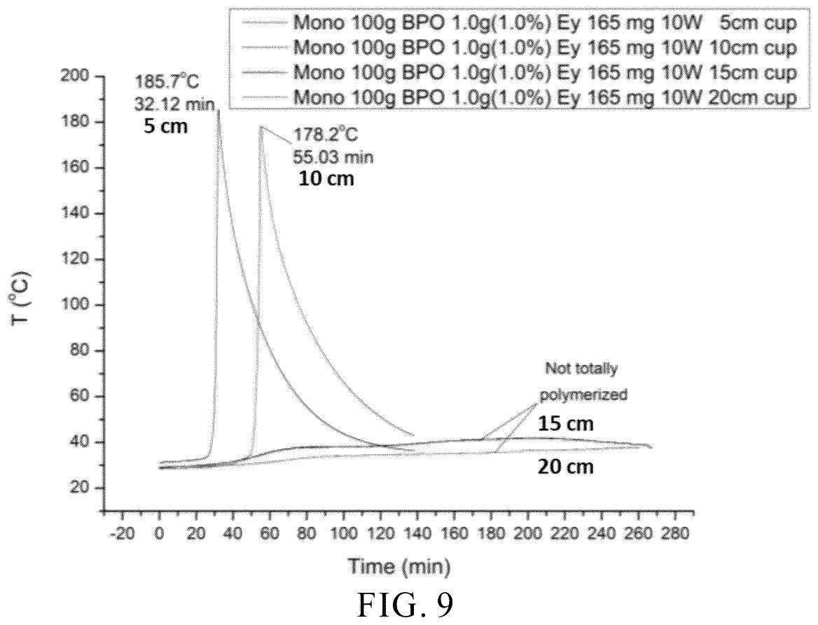

In order to know the impact of light intensity on the reaction, this example first conducts power input rating experiments (the instrument used is Coherent FieldMAX ll-TOP) based on the distance of the light source. As shown in FIG. 8, the results show that there is an exponential relationship between the light source distance and the energy per unit area of illumination. Based on the measurement results, experiments of the impact of light source distance on polymerization reactions were conducted. The results showed that when the light source distance was greater than 15 cm, polymerization could not be completed due to insufficient energy received per unit area. As shown in FIG. 9, when the distance is 5 cm (the energy per unit area is about 4.25 W/cm²), it has the fastest polymerization speed and is accompanied by a higher exothermic temperature. According to the results, the light source should be selected to provide a power of more than 2.0 W/cm² to enable complete polymerization at a lower polymerization temperature. Lowering the light power will lower the polymerization temperature and prolong the polymerization time.

### Example 8: Polymerization Reaction at Low Temperature (100 g Vinyl Ester Monomer, 1 g BPO, 165 mg Eosin Y, 4 cm Thickness)

A first composition comprising 100 g of vinyl ester monomer was provided, and 165 mg of the photosensitizer Eosin Y and 1 g of the organic peroxide benzoyl peroxide (BPO) were used as the co-initiator and added into the first composition to form a second composition, which was irradiated with an actinic ray under a low temperature condition, thereby curing the second composition to form cured vinyl ester resin up to 4 cm thickness.

Traditionally, vinyl ester resin cannot perform the polymerization reaction in an environment below 15° C. even if it is cooperated with an initiator, which greatly limits the production of super-large workpieces in the factory that cannot have temperature control.

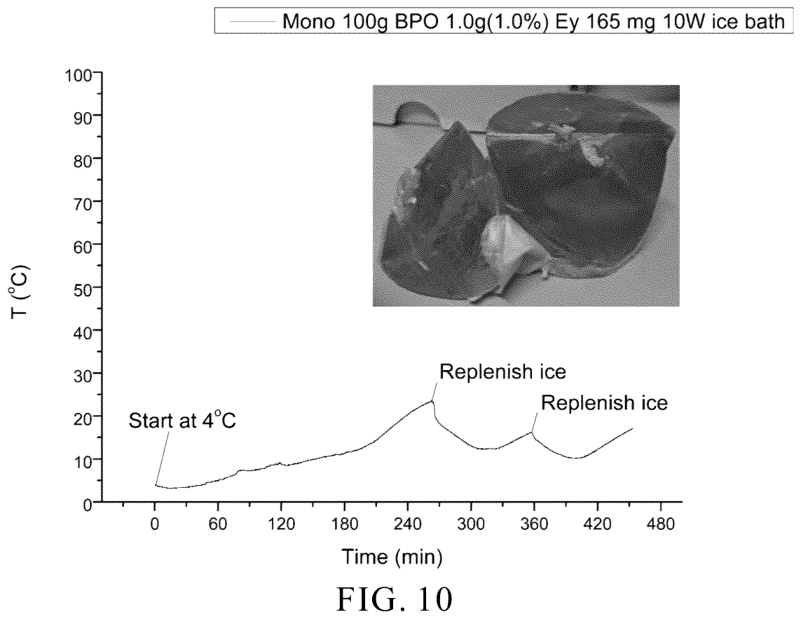

As shown in FIG. 10, this example can effectively overcome this low temperature limitation. It can be seen from FIG. 10 that even if the ambient temperature is continuously maintained at low temperature (4° C.), the reaction can still be initiated by light irradiation, and the system temperature will gradually increase to ˜30° C. with the reaction exothermicity, and finally the polymerization will be successfully completed. Since the starting temperature of BPO self-cleavage to generate free radicals is about 80° C., when the reaction is maintained at low temperature and the polymerization can still be completed, it can be confirmed that the reaction mechanism of this example is indeed a two-stage reaction, in which the light energy is absorbed by Eosin Y and then transformed internally into chemical energy to trigger the BPO cleavage, rather than the spontaneous reaction of BPO, and the two-stage reaction further initiates the chain reaction of polymerization. This is the first case of visible light photopolymerization at an ambient temperature below 25° C. Although the polymerization takes a long time, the results show that large pieces can also be prepared through premix of vinyl ester resin, photosensitizer and peroxide under low temperature conditions before infusion. After the infusion is completed, light is irradiated to start the reaction for polymerization, the low temperature limit can be overcome, and both excellent perfusion control and accuracy can be achieved.

Based on the above, the method for curing vinyl ester resin of the present disclosure, by using the photosensitizer and peroxide as the co-initiator, has at least the following excellent technical effects.
1. By regulating the ratio of the photosensitizer and peroxide, the maximum temperature can be limited, internal defects caused by high reaction temperatures can be reduced, and product performance can be improved.
2. The start-up time of curing can be accurately controlled by starting the reaction with light. The super large workpieces, such as masts or ship hulls, can be formed into one piece without separate infusions, and the curing process can be started after the entire infusion is completed and the inspection and defect correction are done, which can improve the mechanical strength and make the ship stronger and safer.
3. When applied to functional composite materials, due to the addition of electrical or acoustic functions, the thickness and pores of the finished workpiece often need to be controlled with higher precision. However, It is often impossible for the large-scale infusion workpiece to achieve precise thickness control or reduce pores due to resin gravity and difficulty in vacuum suction control. Applying the manufacturing method of the vinyl ester resin of the present disclosure can fine-tune the curing by regional illumination, achieve high-precision control, and obtain better functional product performance.
4. For low-temperature environments in winter, it is generally hard to find corresponding large-scale temperature-controlled factories for the production of super-large workpieces, which limits the season and region of production. The manufacturing method of vinyl ester resin of the present disclosure can assist in the vacuum infusion operation of vinyl ester resin composite materials in low-temperature environments and is not limited by ambient temperature.

While the present invention has been described by means of specific embodiments, numerous modifications and variations could be made thereto by those skilled in the art without departing from the scope and spirit of the present invention set forth in the claims.

What is claimed is:

1. A method for curing vinyl ester resin, comprising:
(a) providing a first composition comprising a vinyl ester monomer;
(b) adding a photosensitizer and a peroxide as a co-initiator to the first composition to form a second composition; and
(c) irradiating the second composition with an actinic ray to cure the second composition.

2. The method of claim 1, wherein the vinyl ester monomer is produced by an esterification reaction of an epoxy resin and methacrylic acid.

3. The method of claim 1, wherein the first composition further includes a solvent.

4. The method of claim 3, wherein the solvent is styrene.

5. The method of claim 1, wherein the photosensitizer is Eosin Y.

6. The method of claim 1, wherein the peroxide is an organic peroxide.

7. The method of claim 6, wherein the organic peroxide is selected from the group consisting of benzoyl peroxide (BPO) and dilauroyl peroxide (DAPO).

8. The method of claim 1, wherein the actinic ray is visible light.

9. The method of claim 1, wherein the actinic ray has an intensity between 10W and 40W.

10. The method of claim 1, wherein a content of the photosensitizer in the second composition is between 0.1 wt % and 0.3 wt %.

11. The method of claim 10, wherein the content of the photosensitizer in the second composition is between 0.13 wt % and 0.2 wt %.

12. The method of claim 1, wherein a content of the peroxide in the second composition is between 0.5 wt % and 2.0 wt %.

13. The method of claim 12, wherein the content of the peroxide in the second composition is between 1.0 wt % and 2.0 wt %.

14. The method of claim 1, wherein step (c) is carried out under a condition of ambient temperature lower than 25° C.

15. The method of claim 1, wherein step (b) further comprises mixing the second composition with a fiber.

16. The method of claim 15, wherein the fiber is glass fiber.
